(19) United States
(12) Patent Application Publication
(10) Pub. No.: US 2026/0186951 A1
(43) Pub. Date: Jul. 2, 2026

(54) MODEL LEVEL DEBUGGING OF MACHINE LEARNING DESIGNS ON NEURAL PROCESSING UNITS

(71) Applicant: Xilinx, Inc., San Jose, CA (US)

(72) Inventors: Tharun Kumar Ksheerasagar, Jangaon (IN); Hemant Kashyap, Hyderabad (IN); Sadanand Mutyala, Hyderabad (IN); Rajesh Palla, Hyderabad (IN); Prashant Malladi, Hyderabad (IN); Pratyush Ranjan, Patna (IN); Anurag Dubey, Boulder, CO (US); Amit Kasat, Hyderabad (IN); Jason Richard Villarreal, Los Gatos, CA (US); Nishant Mysore, Sunnyvale, CA (US)

(73) Assignee: Xilinx, Inc., San Jose, CA (US)

(21) Appl. No.: 19/005,676

(22) Filed: Dec. 30, 2024

(51) Int. Cl. G06F 11/362; G06F 11/3698

(52) U.S. Cl. CPC G06F 11/3636; G06F 11/3698

(57) ABSTRACT

Model level debugging of a machine learning design includes compiling the machine learning design for execution on target hardware using a compiler. Metadata for the machine is generated. The metadata specifies a mapping of buffers of the machine learning design to a plurality of memory levels of a memory architecture of the target hardware correlated with boundaries of the machine learning design. While running the machine learning design, debug data is dumped from the plurality of memory levels of the memory architecture based on the boundaries. The debug data is correlated with the boundaries of the machine learning design based on the metadata.

### RESERVATION OF RIGHTS IN COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to machine learning and, more particularly, to debugging machine learning designs.

### BACKGROUND

Machine learning (ML) designs are complex, having many different layers. The size of a typical ML design is so large that the ML design is executed on target hardware in portions. For example, the target hardware may be unable to store enough data and/or may lack the compute capacity to execute an entire layer of the ML design at one time, e.g., concurrently. To overcome such limitations, each layer of the ML design is subdivided into a plurality of iterations that can be executed the target hardware.

Due to the complexity of both ML designs and the target hardware on which these ML designs are executed, debugging can be exceedingly difficult and time consuming. Available tools provide debugging capabilities once all layers of an ML design have completed execution. This makes tracking down the source of an error particularly difficult. In addition, the available tools often provide debugging information with reference to the low-level hardware of the target hardware on which the ML design executes. This further complicates the process of determining the source of an error within the ML design.

### SUMMARY

In one or more implementations, a method includes compiling a machine learning (ML) design for execution on target hardware using a compiler. The method includes generating, by the compiler, metadata for the ML design. The metadata specifies a mapping of buffers of the ML design to a plurality of memory levels of a memory architecture of the target hardware correlated with boundaries of the ML design. The method includes, while running the ML design, dumping debug data from the plurality of memory levels of the memory architecture based on the boundaries. The debug data is correlated with the boundaries of the machine learning design based on the metadata.

In one or more implementations, a system includes a data processing array including a memory architecture having a plurality of memory levels. The data processing array is configured to implement a machine learning design and execute iterations and layers of the machine learning design. The system includes a data processing system coupled to the data processing array. The data processing system executes a debug agent that performs operations. The operations include, while the machine learning design runs in the data processing array, dumping debug data from the plurality of memory levels of the memory architecture according to boundaries of the machine learning design specified by metadata. The debug data is correlated with the boundaries of the machine learning design based on the metadata.

In one or more implementations, a system includes a hardware processor and a computer-readable storage medium having program instructions stored thereon that cause the processor to perform operations. The operations include compiling an ML design for execution on target hardware using a compiler. The operations include generating, by the compiler, metadata for the ML design. The metadata specifies a mapping of buffers of the ML design to a plurality of memory levels of a memory architecture of the target hardware correlated with boundaries of the ML design. The operations include, while running the ML design, dumping debug data from the plurality of memory levels of the memory architecture based on the boundaries. The debug data is correlated with the boundaries of the machine learning design based on the metadata.

This Summary section is provided merely to introduce certain concepts and not to identify any key or essential features of the claimed subject matter. Many other features and implementations of the disclosed technology will be apparent from the accompanying drawings and from the following detailed description.

### BRIEF DESCRIPTION OF THE DRAWINGS

The accompanying drawings show one or more implementations of the disclosed technology. The drawings, however, should not be construed to be limiting of the implementations to only the examples shown. Various aspects and advantages will become apparent upon review of the following detailed description and upon reference to the drawings.

FIG. 1 illustrates an example of a framework for debugging machine learning (ML) designs intended to execute on target hardware.

FIG. 2 illustrates an example of target hardware for executing an ML design in accordance with one or more implementations of the disclosed technology.

FIG. 3 illustrates an example data flow between different memory levels of a multi-level memory architecture of target hardware for an ML design.

FIG. 4 illustrates an example of metadata as generated by an ML compiler.

FIGS. 5A and 5B, taken collectively, illustrate an example method of certain operative features of the framework of FIG. 1.

FIG. 6 illustrates an example of a data processing system for use with the implementations described herein.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to machine learning and, more particularly, to debugging machine learning designs. Within this disclosure, a machine learning (ML) design may be considered the same as an ML model. In accordance with the implementations described within this disclosure, methods, systems, and computer program products are provided that are capable of performing debugging of ML designs. The implementations address certain inefficiencies of current ML design debugging techniques that only allow for verification of the ML design after all layers of the ML design have finished execution.

In a typical scenario, an ML design may include hundreds of layers with each layer running approximately 10-100 kernel iterations. In cases where the ML model generates incorrect data, identifying the particular layer and/or iteration responsible for the error can be difficult, resulting in a complex and time-consuming debugging process. The implementations described within this disclosure provide debugging that may be performed at the ML model level as opposed to being performed from the perspective of the low-level hardware of the target hardware.

In one or more implementations, a debugging framework is disclosed for debugging ML designs intended to be run, e.g., execute, on target hardware. An ML compiler is capable of generating metadata for a compiled ML design. The metadata may specify a mapping of the ML design to low-level hardware of the target hardware. As an example, the metadata may specify a mapping of different data items consumed and/or generated through execution of the ML design to particular components of the target hardware. The metadata, for example, may label the data items with layer information for the ML design and component data for the target hardware. By mapping debug data dumped from execution of the ML design to particular locations within the structure of the ML design using the metadata, the debug data may be quickly correlated not only with the particular component of the target hardware from which the debug data was obtained, but also may be mapped to a particular layer or iteration of the layer of the ML design responsible for generating the debug data.

The implementations disclosed herein provide debugging capabilities at various points throughout execution of the ML design. In one or more examples, the debugging framework is capable of providing debugging capability at each layer and/or at each iteration of a layer of the ML design. This capability allows for immediate identification and rectification of errors rather than waiting for the entire ML design, e.g., all layers of the ML design, to complete execution.

In one or more examples, the data that is dumped from execution of the ML design may be compared with reference data. The reference data is correct data, e.g., gold standard data, that is expected to be generated from execution of the ML design. By mapping the reference data to the debug data that is dumped from execution of the ML design based on the metadata, the particular reference data for a given layer or iteration of a layer may be compared with dumped data that matches or corresponds to, e.g., by mapping using the metadata, the reference data in terms of the layer, iteration, and/or buffer.

Because data may be dumped at various points throughout execution of the ML design, a comparison of the dumped data with the reference data may be performed at different points throughout execution of the ML design. This provides the capability of immediately identifying/detecting errors and rectifying errors in the ML design, thereby significantly reducing the time and complexity of debugging an ML design.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

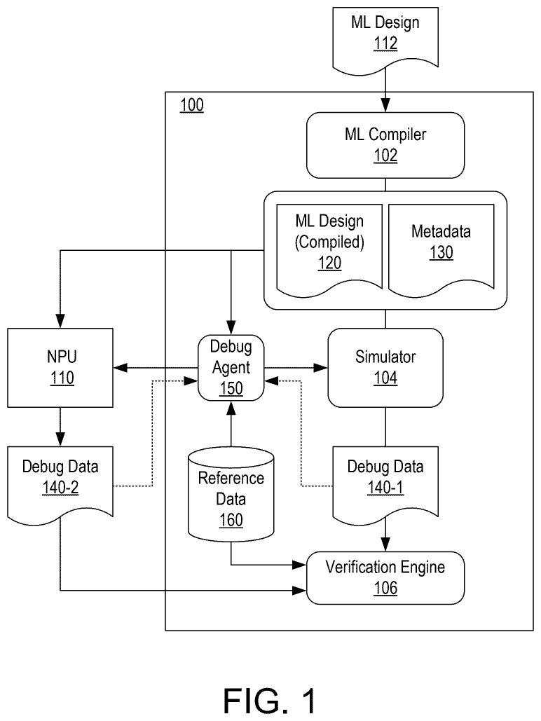

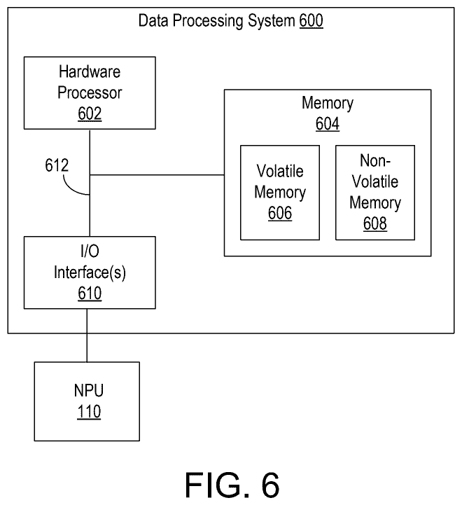

FIG. 1 illustrates an example of a framework 100 for debugging ML designs. Framework 100 may be implemented as program instructions that may be executed by a data processing system. An example of a data processing system that is capable of executing framework 100 is described in connection with FIG. 6. In one or more implementations, framework 100 may be embodied as a computer-based Electronic Design Automation (EDA) tool.

In the example, framework 100 includes an ML compiler 102, a simulator 104, and optionally a verification engine 106. A Neural Processing Unit (NPU) 110 is shown in FIG. 1 for purposes of illustrating different aspects of the disclosed implementations but is not considered part of framework 100 as NPU 110 is an example of target hardware on which the compiled version of ML design 112 is intended to execute.

A neural processing unit (NPU) is a variety of hardware typically embodied as an integrated circuit (IC). An NPU is implemented to include a plurality of compute units, e.g., computer microprocessors. The architecture of an NPU is often described as one capable of mimicking certain processing functions of the human brain. An NPU is often optimized for performing or executing artificial intelligence (AI) neural networks, deep learning, and/or ML tasks and applications.

The implementations and examples described within this disclosure are described in connection with an NPU (e.g., NPU 110). It should be appreciated that an NPU is used for purposes of illustration and not limitation. The implementations and examples described herein may be used with any of a variety of processors (e.g., ICs) capable of executing ML designs that include memory architectures with multiple memory levels. The implementations and examples may be used with processors that include multiple compute units/circuits capable of performing parallel operations. Examples of other types of target hardware capable of executing ML designs and with which the implementations and examples may be used may include, but are not limited to, central processing units (CPUs), graphics processing units (GPUs), or other digital signal processor (DSP) architectures.

In the example, ML compiler 102 is capable of compiling ML design 112 to generate ML design 120. In general, NPU 110, in executing ML design 120, does so by processing ML design 120 in multiple layers. Each layer may be further subdivided into a plurality of portions or segments referred to herein as iterations. The iterations depend on the memory capacity and processing capacity of NPU 110. ML compiler 102, in generating ML design 120, is capable of compiling each layer of the multiple layers of ML design 112. Further, ML compiler 102 is capable of subdividing, e.g., tiling, layers of ML design 112 into a plurality of iterations. Each iteration, for example, may operate on a particular sub-volume of the input data for a given layer of ML design 112. In one or more examples, ML design 120 is embodied as program instructions and/or data that may be loaded into NPU 110 to physically realize ML design 112 therein. Similarly, ML design 120 may be loaded into a simulator 104 to simulate execution of ML design 120 on a CPU, e.g., a computer.

In addition to generating ML design 120, ML compiler 102 is capable of generating metadata 130, which may be specified as a file or stored in a physical memory as a data structure. In one or more examples, metadata 130 specifies a list of data structures that are processed through execution of ML design 120, whether by simulator 104 and/or by NPU 110. For example, the data structures may include input data provided to ML design 120 (input feature maps or “IFMs”), weights of layers of ML design 120, and data generated by ML design 120 as output (output feature maps or “OFMs”).

Metadata 130 further specifies a mapping of the data structures to particular low-level circuitry, e.g., components, of NPU 110. In this regard, metadata 130 specifies how ML compiler 102 has allocated hardware resources of NPU 110. As an example, metadata 130 may specify that a particular data structure is stored as a particular named buffer within a particular component (e.g., a particular memory) of NPU 110. This type of data may be specified by metadata 130 on a per iteration and/or per layer basis for ML design 120. Further aspects of metadata 130 are described in greater detail hereinbelow. In general, metadata 130 may be used in simulating an ML design and/or in executing an ML design on the actual target hardware.

In the example of FIG. 1, ML design 120 may be executed, e.g., simulated, by simulator 104 to generate debug data 140-1. ML design 120 also may be executed by NPU 110. Continuing with the simulation example, simulator 104 may execute in coordination with a debug agent 150 that is implemented as executable program code. In one or more examples, debug agent 150 may be built into simulator 104. In one or more other examples, debug agent 150 may be implemented as a separate process within framework 100 and/or the data processing executing framework 100. Debug agent 150 is capable of outputting, e.g., dumping, debug data 140-1 from execution of ML design 120 during the simulation based on known boundaries of ML design 120. A boundary refers to a particular iteration and/or layer of ML design 120 (e.g., the completion of execution of such iteration or boundary). State information for selected components of the NPU as simulated also may be output as part of debug data 140-1.

In one or more examples, debug agent 150, as executed by a data processing system, is capable of communicating with NPU 110 while NPU 110 executes ML design 120. For example, debug agent 150 may be implemented as an external process relative to NPU 110 that attaches to ML design 120 as executed by NPU 110 (e.g., the application under debug). In the example, debug agent 150 is capable of dumping debug data 140-2 from execution of ML design 120 in the target hardware. Debug data 140-2 may be the same as, or substantially similar to, debug data 140-1. The debug data dumped from execution of ML design 120 in hardware may be output to the data processing system executing framework 100 for use by verification engine 106 and/or debug agent 150.

In the case of execution of ML design 120 by simulation and in target hardware such as NPU 110, debug agent 150 may operate as a process similar to known debuggers that control execution of another process, e.g., ML design 120. In one or more examples, debug agent 150 may execute as a separate process (e.g., a separate process than the simulation or a separate process from other processes of the data processing system). In this manner, debug agent 150 is capable of monitoring and/or controlling (e.g., stepping) the execution of ML design 120. In general, debug agent 150 is capable of detecting well-defined points during execution of ML design 120, e.g., boundaries, based on metadata 130. Metadata 130 may define a set of memory locations of interest and that debug agent 150 is to dump at these different points of execution of ML design 120.

Verification engine 106 is capable of comparing reference data 160 with debug data 140 (e.g., with debug data 140-1 and/or 140-2). The comparisons may be performed on a per iteration basis, on a per layer basis, and/or at the conclusion of execution of ML design 120 in either simulator 104 and/or in NPU 110. In the example, verification engine 106 is capable of matching portions of debug data 140 with portions of reference data 160 by matching or correlating information in debug data 140 with information in reference data 160 obtained from metadata 130. For example, verification engine 106 is capable of matching portions of data based on iteration number (with reference to a particular layer of ML design 120), layer, buffer name, and/or buffer location in reference to the particular memory level in the memory architecture of the target hardware (and/or as simulated in simulator 104) from which the debug data 140 was dumped. Reference data 160 also may include state data for one or more selected components of NPU 110 (or NPU 110 as simulated by simulator 104) that may be compared with corresponding state data included in debug data 140. The state data also may be specified on a per iteration and/or per layer basis.

In one or more examples, verification engine 106 is optional and, as such, may be omitted. In one or more other examples, comparisons of debug data 140 with reference data 160 may be performed by debug agent 150. Such comparisons may be performed during runtime of ML design 120, e.g., following one or more or each execution of an iteration and/or layer of ML design 120. For example, comparisons may be performed, by verification engine 106 or debug agent 150, on a per-layer basis in response to completing execution of one or more layers of the machine learning design.

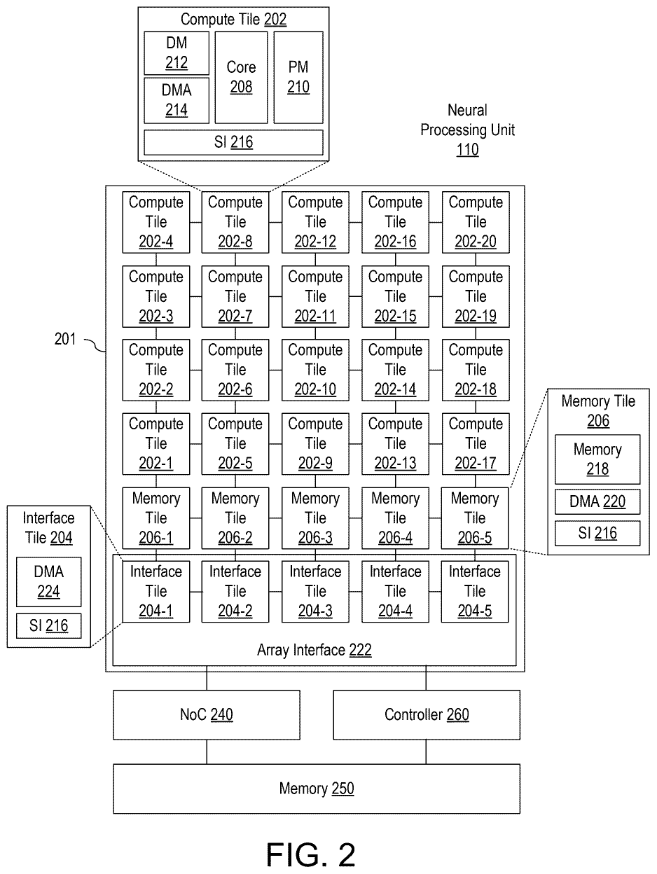

FIG. 2 illustrates an example of target hardware capable of executing ML design 120. For purposes of illustration, the target hardware is NPU 110. In the example, NPU 110 includes a data processing array 201 including a plurality of interconnected tiles. The term “tile,” as used herein in connection with data processing array 201, means a circuit block. The interconnected tiles of NPU 110 include compute tiles 202, interface tiles 204, and memory tiles 206. The tiles illustrated in FIG. 2 may be arranged in an array or grid and are hardwired.

Each compute tile 202 can include one or more cores 208, a program memory (PM) 210, a data memory (DM) 212, a DMA circuit 214, and a stream interconnect (SI) 216. In one aspect, each core 208 is capable of executing program code (e.g., a kernel) stored in program memory 210. In one aspect, each core 208 may be implemented as a scalar processor, as a vector processor, or as a scalar processor and a vector processor operating in coordination with one another. Compute tiles 202 implement the computational capabilities of NPU 110.

In one or more examples, each core 208 is capable of directly accessing the data memory 212 within the same compute tile 202 and the data memory 212 of any other compute tile 202 that is adjacent to the core 208 of the compute tile 202 in the up, down, left, and/or right directions. Core 208 sees data memories 212 within the same tile and in one or more other adjacent compute tiles 202 as a unified region of memory (e.g., as a part of the local memory of the core 208). This facilitates data sharing among different compute tiles 202 in NPU 110. In other examples, core 208 may be directly connected to data memories 212 in other compute tiles 202.

Cores 208 may be directly connected with adjacent cores 208 via core-to-core cascade connections (not shown). In one aspect, core-to-core cascade connections are unidirectional and direct connections between cores 208. In another aspect, core-to-core cascade connections are bidirectional and direct connections between cores 208. In general, core-to-core cascade connections generally allow the results stored in an accumulation register of a source core 208 to be provided directly to an input of a target or load core 208 bypassing, e.g., without traversing, the stream interconnect 216 (e.g., without using DMA circuit 214) and bypassing data memory, e.g., without being written by a first core 208 to data memory 212 to be read by a different core 208.

In one or more examples, compute tiles 202 do not include cache memories. More particularly, the memories illustrated in NPU 110 omit predictive data loading circuitry (e.g., omit data “hit” or “miss” mechanisms). Data that is used by any given compute tile 202, for example, is expected to be at the location or in the particular memory accessed. By omitting cache memories (e.g., the hit/miss mechanisms that characterize a cache), NPU 110 is capable of achieving predictable, e.g., deterministic, performance. Further, significant processing overhead is avoided since maintaining coherency among cache memories located in different compute tiles 202 is not required. Also, in one or more examples, because NPU 110 implements a data flow architecture capable of providing deterministic performance, cores 208 do not have input interrupts. In one or more implementations, none of tiles 202, 204, and/or 206 have input interrupts. Thus, cores 208 are capable of operating uninterrupted. Omitting input interrupts to cores 208 and/or the tiles 202, 204, and 206 in general also allows NPU 110 to achieve predictable, e.g., deterministic, performance.

Memory tiles 206 include a memory 218 (e.g., a RAM), a DMA circuit 220, and a stream interconnect 216. Each memory tile 206 may read and/or write to the memory 218 of an adjacent memory tile 206 by way of the DMA circuit 220 included in the memory tile 206. Further, each compute tile 202 in NPU 110 is capable of reading and writing to any one or more of memory tiles 206. Memory tiles 206 are characterized by the lack of computational components such as processors (e.g., cores 208).

Interface tiles 204 form an array interface 222 for NPU 110. Array interface 222 operates as an interface that connects tiles of NPU 110 to other resources of the particular IC in which NPU 110 is disposed. In the example of FIG. 2, array interface 222 includes a plurality of interface tiles 204 organized in a row. Interface tiles 204 can include a stream interconnect 216 and a DMA circuit 224. Interface tiles 204 are connected so that data may be propagated from one interface tile to another bi-directionally. Each interface tile 204 is capable of operating as an interface for the column of tiles directly above and is capable of interfacing such tiles with components and/or subsystems of the IC including NPU 110. Like memory tiles 206, interface tiles 204 are characterized by the lack of computational components such as processors (e.g., cores 208).

In one or more implementations, hardware accelerator NPU 110 may include one or more other subsystems (not shown). For example, NPU 110 may include one or more or each of subsystems including, but not limited to, programmable logic, a processor system, a platform management controller, and one or more hardwired circuit blocks.

In the example of FIG. 2, NPU 110 includes a Network-on-Chip (NoC) 240. NoC 240 supports data transfers between tiles of data processing array 201 and other subsystem(s) of NPU 110 that may be included (not shown) as well as memory 250. In one or more other implementations, NoC 240 may be replaced with other interconnect circuitry such as a connection fabric, cross-bars, or other on-chip interconnects.

In one or more examples, memory 250 may be implemented as a volatile memory such as Random-Access Memory (RAM). For example, memory 250 may be implemented as Double Data Rate (DDR) RAM, High-Bandwidth Memory (HBM), or other volatile memory. In one or more implementations, memory 250 is implemented as on-chip memory (e.g., in the same package as the tiles of NPU 110 and/or on a same die as the tiles of NPU 110). In one or more other implementations, memory 250 may be implemented off-chip. For example, memory 250 may be disposed on a same circuit board and/or card as NPU 110 and external to the package of NPU 110. Appreciably, NPU 110 may include a memory controller (not shown) for accessing memory 250.

Controller 260 may be implemented as circuitry capable of executing program instructions. For example, ML design 120 may be embodied as the program instructions executed by controller 260. In executing ML design 120, controller 260 is capable of controlling operation of the tiles of data processing array 201 by configuring the tiles with configuration data specified by the program instructions. The configuration data, as loaded into the tiles, implements ML design 120.

For example, as part of implementing ML design 120, controller 260 may execute program instructions thereof that cause controller 260 to program DMA circuits 214, 220, and 224 to move data from memory 250, into memory tiles 206, and/or into data memories 212 of compute tiles 202 for performing computations. Controller 260 may program DMA circuits 214, 220, and 224 to move data out data memories 212, into memory tiles 206, and/or into memory 250. Data generated by operation of compute tiles 202 may be stored in data memories 212, in memory tiles 206, and/or be moved to memory 250.

In one or more examples, controller 260 may couple to NoC 240. For instance, controller 260 may couple to memory 250 via NoC 240.

In the example, NPU 110 implements or includes a memory architecture that is formed of data memories 212, memories 218, and memory 250. The memory architecture is hierarchical in nature. For example, though NPU 110 may not include cache memory in that predictive data loading may be omitted, the memory architecture still may be characterized in terms of multiple memory levels with data memories 212 being level 1 (L1) memory, memories 218 being level 2 (L2) memory, and memory 250 being level 3 (L3) memory. In this regard, controller 260 is capable of moving data throughout the different levels of the memory architecture of NPU 110. Controller 260 is also capable of loading program data (e.g., kernels) into program memories 210 of compute tiles 202 to implement ML design 120.

Though not illustrated in the example of FIG. 2, NPU 110 will include one or more interfaces allowing NPU 110 to communicate with other systems and/or devices such as a data processing system hosting/executing framework 100. For purposes of illustration and not limitation, NPU 110 may include a Peripheral Component Interconnect Express (PCIe) bus, A Joint Test Action Group (JTAG) port/interface, and/or other interfaces. Such interfaces may be coupled to components within NPU 110 such as data processing array 201 via interconnect circuitry. In some examples, the interface(s) may be coupled to NoC 240 and/or to controller 260, Debug agent 150 is capable of communicating with NPU 110 and data processing array 201 via such interfaces in real time and/or in substantially real time to perform the operations described herein.

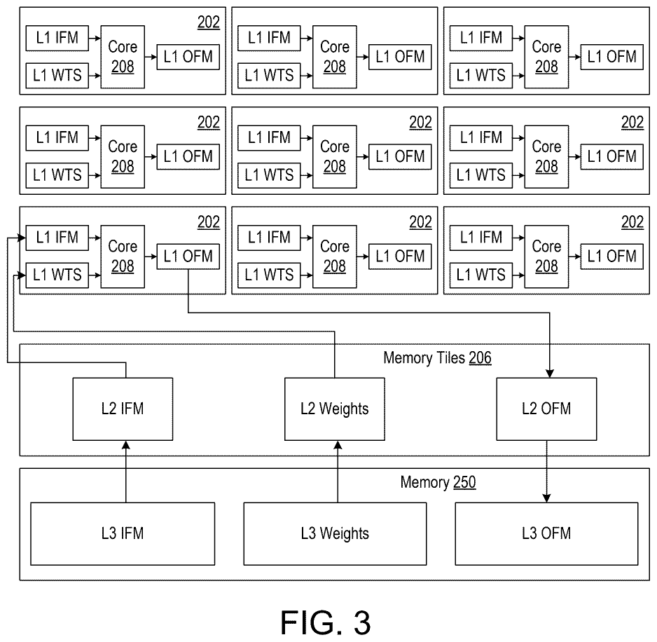

FIG. 3 illustrates an example data flow between different memories of a multi-level memory architecture of an NPU. FIG. 3 illustrates data movements and the distribution of different data structures throughout the memory architecture of an NPU such as NPU 110. In the example, L2 memory is implemented as one or more memory tiles 206 and is capable of storing intermittent data. L3 memory is implemented as memory 250 and may be the primary memory that stores actual inputs to ML design 120. L1 memory is implemented as data memories 212 (not shown).

In the example of FIG. 3, L3 memory stores weights, IFMs, and/or OFMs for ML design 120 for different layers. Each type of data may be stored in one or more different buffers within L3 memory as designated by ML compiler 102 and as specified in metadata 130. L2 memory stores weights, IFMs, and OFMs for ML design 120 for different layers. Each type of data may be stored in one or more different buffers within particular and/or different ones of memory tiles 206 as designated by ML compiler 102 and as specified in metadata 130. L1 memory in compute tiles 202 stores weights (WTS), IFMs, and OFMs for ML design 120 for different layers. Each type of data may be stored in one or more different buffers within particular and/or different ones of data memories 212 of compute tiles 202 as designated by ML compiler 102 and as specified in metadata 130.

In one or more examples, data from these different memory levels, e.g., different and/or particular buffers of weights, IFMs, and/or OFMs, may be output or dumped at selected points during operation/execution of ML design 120. As discussed, at each or at selected iterations and/or at each or at selected layers, such data may be output as debug data 140. In addition, with reference to FIG. 2, state data may be output as part of debug data 140. State data may include configuration data for components of NPU 110. As an illustrative and nonlimiting example, state data for DMA circuits 214, 220, and/or 224 may be output as debug data 140. The implementations described herein provide the capability of precisely identifying and extracting particular data at the exact layer or iteration boundary of ML design 120.

As discussed, because the typical ML design is data-intensive, data is split into small portions for optimized implementation. Managing data across L3, L2, and L1 memories complicates debugging. During operation, as illustrated in the example of FIG. 3, a data block moves from L3 memory to L2 memory, then to the respective compute tiles 202. Cores 208 execute operations generating OFMs in L1 memory. The OFMs are transferred to L2 memory and, if necessary, to L3 memory. The final output may be stored in L3 memory and often serves as the input for the next layer of ML design 120.

The memory architecture of NPUs, regardless of the particular circuit architecture or implementation, must perform numerous data transfers of the sort illustrated in FIG. 3 to execute an ML design. If any layer of the ML design generates incorrect output including an error, subsequent layers of the ML design will fail and cause the ML design to malfunction. The implementations described herein provide a verification methodology that is capable of interfacing with both target hardware executing the ML design and a simulation executing the ML design to monitor, in either or both cases, the state of the ML design running (e.g., executing). At defined boundaries of ML design 120, the example implementations described herein are capable of retrieving buffer data from L1, L2, and L3 memories from the NPU or from the simulation based on metadata 130.

The various memories of the memory architecture of NPU 110, e.g., L1, L2, and L3 memories, configuration registers of tiles 202, 204, and 206 (not shown), and program counters of cores 208 (not shown), are memory mapped and therefore accessible to debug agent 150. In one or more implementations, debug agent 150 is capable of including a breakpoint in each compute tile 202 at the start and at the end of the kernel function executed by each respective core 208. In the example, each compute tile 202 may execute the same kernel. Further, each compute tile 202 includes support for setting hardware breakpoints. In this regard, debug agent 150 is capable of communicating with data processing array 201 to set breakpoints before and/or during execution of ML design 120 and initiate the dumping of debug data from one or more selected tiles.

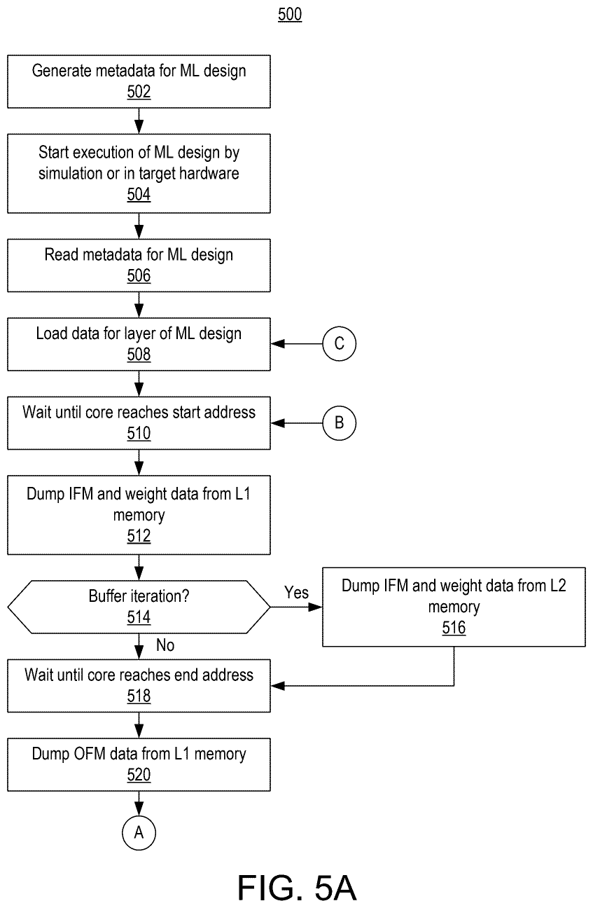

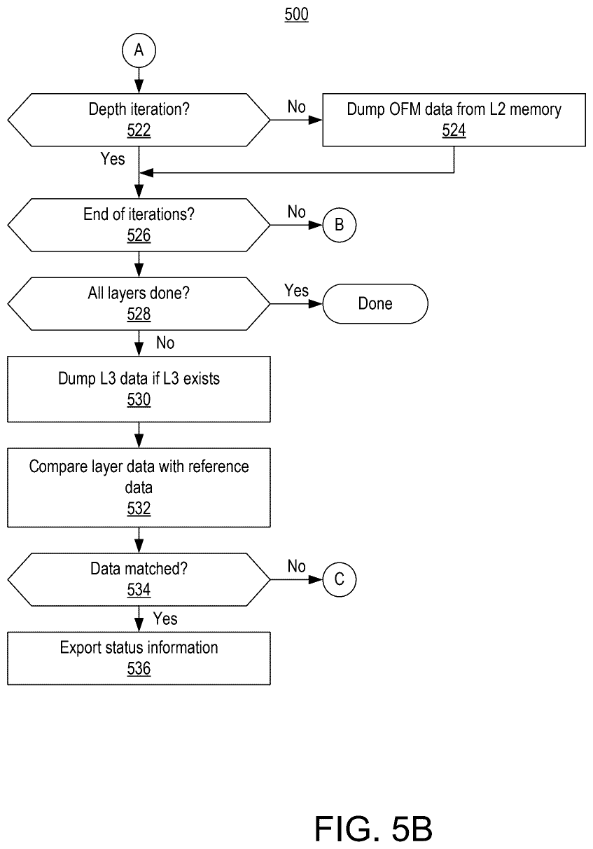

In response to the breakpoint being triggered on each compute tile 202, e.g., a particular program counter value being reached, debug agent 150 is capable of dumping data stored in L1 memory (e.g., the data from each data memory 212 of each compute tile 202), data stored in L2 memory (e.g., the data stored in each memory tile 206 or in selected memory tiles 206 storing buffers of interest, and/or data from L3 memory (e.g., memory 250). For example, in response to the start breakpoint, debug agent 150 is capable of dumping IFMs. In response to detecting an end breakpoint, debug agent is capable of dumping OFMs. This process is described in greater detail with reference to FIG. 5.

As ML design 120 executes, IFMs may be moved from L3 memory to L2 memory and/or OFMs may be moved from L2 memory to L3 memory every N kernel iterations. Debug agent 150 is capable of tracking each iteration (e.g., of a kernel) and maintaining or storing an iteration count. This may be performed for a selected compute tile 202 as each compute tile 202 may execute a same kernel or may be performed for each compute tile 202. Debug agent 150 may dump L2 data every N iterations. The value of N may vary and be set from one layer of ML design 120 to another based on metadata 130. Debug agent 150 is capable of dumping L1 data each iteration.

In one or more examples, whether performed by verification engine 106 or debug agent 150, data dumped as described may be analyzed by comparing characteristics of the data with known characteristics specified by metadata 130. For example, metadata 130 may describe characteristics of expected data dumped from L1, L2, and/or L3 memory such as offsets of the data and/or buffers dumped, sizes of data and/or buffers dumped, and intervals of data and/or buffers dumped (e.g., the iteration and/or layer for which the IFMs and WTS are provided and/or the iteration and/or layer that generated the OFMs).

In some cases, compute tiles 202 may have limited storage for storing breakpoints. In one or more examples, debug agent 150 is capable of moving the breakpoints to each successive layer as execution of ML design 120 continues. For example, debug agent 150 may remove current breakpoints for a layer that completes execution and insert new breakpoints at the start and end of for a kernel (for the new set of iterations and/or layer to be executed).

As part of dumping data from the memory architecture of NPU 110 (whether physically or through simulation), state information of components such as DMA circuits 214, 220, and/or 224 may be output at each breakpoint, at selected breakpoints, or in response to detecting particular conditions. In one or more examples, debug agent 150 is capable of monitoring status registers of such DMA circuits to detect when data has moved from L3 memory to L2 memory and/or from L2 memory to L3 memory. For example, debug agent 150 may operate in an interactive mode in which execution of ML design 120 may be stopped at any of the various points during execution described herein or stepped through such points. At any of these points, in response to a user command to do so, debug agent 150 may dump debug data as described as well as other state data pertaining to NPU 110 (or a simulation thereof) such as contents of any hardware registers at any address offset as such registers and/or memories of the entire NPU 110 may be addressable. Any state information read from an address, whether memory and/or other register, may be mapped to the particular component of NPU 110 from which the data was obtained.

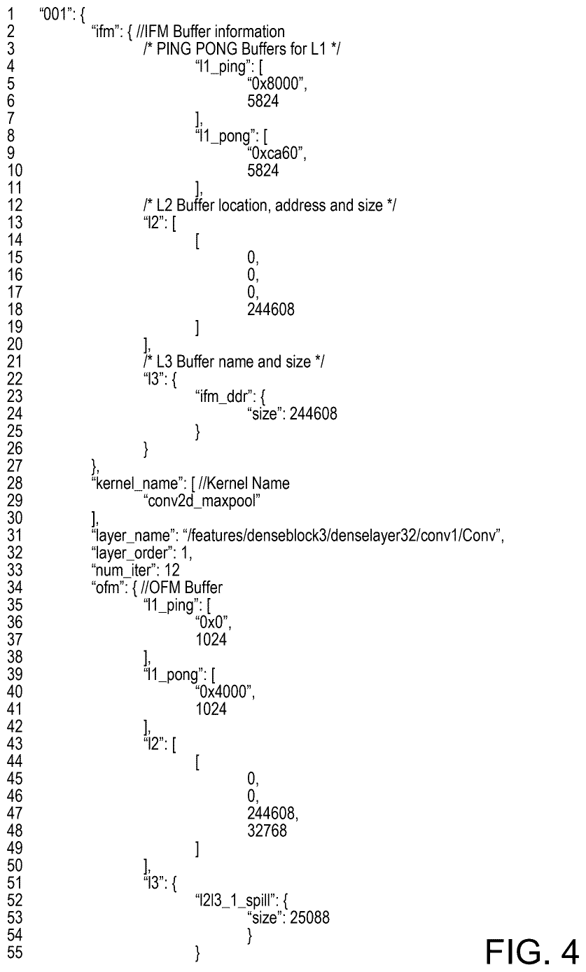

FIG. 4 illustrates an example of metadata 130 as generated by ML compiler 102. The example of FIG. 4 illustrates buffer information in terms of location (e.g., address), size, iteration, and layer may be specified. Debug agent 150 may monitor execution of ML design 120 using the information specified in metadata 130 to set breakpoints and dump data (e.g., read selected tiles of data processing array 201 to output or dump data and/or instruct selected tiles of data processing array 201 to output or dump data) from the various buffers of interest by accessing the particular addresses of the memory architecture of NPU 110 based on metadata 130.

Data dumped by debug agent 150 during simulation and/or from NPU 110 may be stored in one or more files in a data processing system. As an example, files including debug data may include buffer name, iteration number, and/or layer information. State information may specify the particular component from which the state information was obtained by specifying an address of the configuration and/or status register from which the state information was obtained. Any address may be correlated with, or mapped to, a particular component (e.g., particular tile and/or component within a tile) of NPU 110. Data dumped by debug agent 150 from NPU 110 may be output via any of the available interfaces of NPU 110 to memory 250 and/or to a data processing system to be stored in one or more files as described herein.

FIGS. 5A and 5B, taken collectively and collectively referred to as FIG. 5, illustrate an example method 500 of certain operative features of framework 100 described in connection with FIG. 1. Method 500 may begin with ML compiler 102 compiling ML design 112 to generate ML design 120. In the example of FIG. 5, as the implementations described within this disclosure may be implemented in the context executing ML design 120 within a simulation or using target hardware (e.g., in NPU 110), references to NPU 110 or components thereof may refer to actual hardware in the case of executing ML design 120 using target hardware or to virtual or simulated versions of such hardware in the case of simulation.

Either following compilation or as part of the compilation process, ML compiler 102 is capable of generating metadata 130 for ML design 120 in block 502. As discussed, metadata 130 may describe buffers for each iteration and/or layer of ML design 120 in terms of buffer name, type of data in the buffer (e.g., IFMs, WTS, or OFMs), a location such as an address that may be mapped to a particular hardware component of NPU 110, and addresses for other state data that may be stored in configuration registers of tiles of NPU 110.

In block 504, a simulation of ML design 120 may be started by simulator 104. In addition, or in the alternative, ML design 120 may be executed in target hardware, e.g., by loading and running ML design 120 in NPU 110. In block 506, debug agent 150 is capable of reading metadata 130.

In block 508, the data for implementing a layer (e.g., a first layer) of ML design 120 may be loaded. In block 508, for example, the data (e.g., WTS and IFMs) may be loaded into the various memory levels of the memory architecture of NPU 110. As discussed, ML design 120 may include the instructions and/or data for programming DMA circuits (or simulations thereof) to move data through the memory architecture. In one or more examples, as part of block 508, the start breakpoint and end breakpoint also may be loaded into, or set within, compute tiles 202 as discussed.

In block 510, each of compute tile 202 may begin operation. Each compute tile 202 may begin execution and take no action in terms of dumping data until the start breakpoint has been detected or encountered by the core 208 of the respective compute tile 202. In block 512, in response to encountering the start breakpoint set by debug agent 150, data stored in L1 memory may be dumped. Any data such as IFMs and/or weights from each data memory 212 may be dumped to a specified location or file.

In the example of FIG. 5, data may be dumped from one or more selected memory levels of the memory architecture of NPU 110 in response to a condition, or conditions, as described herein. The detected conditions indicate a change in state in the data stored in the selected memory level(s) at different points throughout execution of ML design 120. Such changes in state may be indicated by the breakpoints described and/or by monitoring state data in selected components of NPU 110 such as, for example, DMA circuits.

In block 514, debug agent 150 is capable of detecting whether a buffer iteration has occurred. A buffer iteration refers to a number of iterations of a kernel as executed by a core 208 of a compute tile 202 that is performed before data from L2 memory has been consumed and another chunk of data must be transferred from L3 memory to L2 memory, for subsequent transfer to L1 memory for use by cores 208. In response to detecting that the kernel iteration that completed execution is a buffer iteration, method 500 continues to block 516. In response to detecting that the kernel iteration that completed execution is not a buffer iteration, method 500 continues to block 518. Debug agent 150 may monitor execution of ML design 120 by monitoring program counter values in core(s) 208 and counting iterations knowing the number of iterations required for detecting a buffer iteration from metadata 130.

In block 516, debug agent 150 is capable of dumping data from L2 memory. For example, debug agent 150 is capable of dumping the IFMs and weights from L2 memory as that data has been consumed through execution of ML design 120 and will be overwritten with new data transferred from L3 memory. In block 518, each of compute tiles 202 may continue operation (e.g., execution of the kernel therein) and take no action in terms of dumping data until the end breakpoint has been detected or encountered by the core 208 of the respective compute tile 202. In block 520, in response to encountering the end breakpoint set by debug agent 150, debug agent 150 may dump OFM data that has been generated and stored in L1 memory (e.g., data memories 212).

In block 522, debug agent 150 is capable of detecting whether the iteration of the kernel that just completed execution is a depth iteration. A depth iteration is a number of iterations of a kernel by a core 208 required to obtain or generate an output, e.g., an OFM, that is transferred from L1 memory to L2 memory. The detection of a depth iteration may be performed by debug agent 150 monitoring execution of kernels by cores 208 based on metadata 130. Debug agent 150 may monitor execution of ML design 120 by monitoring program counter values in core(s) 208 and counting iterations knowing the number of iterations required for detecting a depth iteration from metadata 130. In response to detecting that the iteration that just completed execution is a depth iteration, method 500 continues to block 526. In response to detecting that the iteration that just completed execution is not a depth iteration, method 500 loops back to block 510 to continue processing as described.

In block 524, debug agent 150 is capable of dumping OFM data from L2 memory. In block 524, debug agent 150 is capable of dumping the OFM data from L2 memory as OFM data has been stored and new OFM will subsequently be stored, e.g., after the dump operation, that overwrites the existing or current OFM data.

In block 526, debug agent 150 is capable of detecting whether the number of iterations to complete the current layer of ML design 120 have completed execution. The number of iterations in each layer of ML design 120 may be specified in metadata 130. In response to detecting the last iteration of the current layer of ML design 120, method 500 may continue to block 528. In response to detecting that the current iteration is not the last iteration of the current layer of ML design 120, method 500 may continue to block 510 to continue monitoring further iterations of the current layer of ML design 120.

In block 528, debug agent 150 is capable of detecting whether all layers of ML design 120 have completed execution. Metadata 130 may specify the total number of layers in ML design 120. In response to detecting that all layers of ML design 120 have completed execution, method 500 may end. In response to detecting that one or more layers of ML design 120 remain to be executed, method 500 may continue to block 530. In block 530, debug agent 150 is capable of dumping data from L3 memory, if any such data for ML design 120 exists or remains (e.g., has not been consumed).

In block 532, debug agent 150 is capable of comparing debug data 140 for the layer that completed execution with reference data 160. In some examples, reference data 160 may be available. For example, the IFMs may be known values for which expected output data may be generated or calculated as reference data 160 and compared against debug data 140 obtained for the layer. As part of the comparing, in some examples, debug agent 150 is capable of cleaning the debug data to eliminate any padding that may be present. Debug agent 150 is capable of comparing the data as cleansed with reference data 160.

In block 534, debug agent 150 is capable of detecting whether the layer data of debug data 140 matches reference data 160 for the layer. In response to detecting that the layer data of debug data 140 does not match reference data 160 for the layer, method 500 may continue to block 536 where state information of NPU 110 may be output.

For example, in block 536, debug agent 150 is capable of reading data stored in configuration and/or status registers of hardware components of NPU 110 (or simulations thereof) such as DMA circuits and output such state data as part of debug data 140. In response to detecting that the layer data of debug data 140 does match the reference data, method 500 may continue to block 508 to begin execution and monitoring of a next layer of ML design 120. In one or more examples, error flags may be generated by NPU 110 and may be stored in the status registers and output as part of the state information.

In one or more other examples, certain operations illustrated in FIG. 5 such as blocks 532 and/or 534 may be performed by another system. For example, a verification engine 106 may be used that is executed by a data processing system. Verification engine 106 may receive debug data 140 (e.g., on a per-layer basis), metadata 130, and reference data 160 to perform the comparison to detect mismatches. Verification engine 106 may provide any results to debug agent 150 such that debug agent 150 may continue with execution and monitoring of ML design 120 or discontinue execution of ML design 120 based on the results received.

The example of FIG. 5 is provided for purposes of illustration and not limitation. In one or more examples, state information for components of NPU 110, physical or simulated, may be output routinely regardless of whether a mismatch in data is detected. In one or more other examples, the comparison of layer data as performed in blocks 532 and 534 may be optional and, as such, omitted. In that case, after block 530 or block 536 in the case where state information is output regularly, method 500 may loop back to block 508.

FIG. 6 illustrates an example of a data processing system 600. As used herein, “data processing system” refers to one or more hardware systems capable of processing data. Each hardware system may include one or more hardware processors and memory.

Data processing system 600 includes a hardware processor 602. Hardware processor 602 may be implemented as one or more hardware processors. Hardware processor 602 may be implemented as one or more circuits capable of executing computer-readable program instructions (program instructions). The circuit(s) may comprise integrated circuits (ICs) or may be embedded within an IC. In one or more examples, hardware processor 602 may be embodied as a central processing unit (CPU). Hardware processor 602 may include one or more cores, for example, where each core is capable of executing computer-readable program instructions. Hardware processor 602 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like.

Data processing system 600 can include memory 604. Memory 604 may be embodied as one or more computer-readable storage mediums. Memory 604 may include a volatile memory 606 and a non-volatile memory 608. Volatile memory 606 may be embodied as random-access memory (RAM) and may include cache memory. Volatile memory 606 may be referred to as “runtime memory.” Non-volatile memory 608 may include a non-volatile magnetic medium and/or a solid-state medium (typically called a “hard drive”). Non-volatile memory 608 also may include one or more disk drives capable of reading from and writing to various types of removable, non-volatile mediums such as a removable, non-volatile magnetic disk (e.g., a “floppy disk”) and/or a removable, non-volatile optical disk such as a CD-ROM, DVD-ROM or other optical media.

Memory 604 is capable of storing program instructions and/or data such that hardware processor 602 is capable of executing the program instructions to perform one or more operations as described within this disclosure. For example, the program instructions can include an operating system, one or more application programs, other program code, and program data. In one or more examples, the program code and/or data may implement framework 100 of FIG. 1. Hardware processor 602, in executing the computer-readable program instructions, is capable of performing the various operations described herein that are attributable to a computer.

Data processing system 600 may include one or more Input/Output (I/O) interfaces 610. I/O interface(s) 610 allow data processing system 600 to communicate with one or more external devices and/or communicate over one or more networks such as a local area network (LAN), a wide area network (WAN), and/or a public network (e.g., the Internet). Examples of I/O interfaces 610 may include, but are not limited to, network cards, modems, network adapters (wired and/or wireless), hardware controllers, etc. Examples of external devices also may include devices that allow a user to interact with data processing system 600 (e.g., a display, a keyboard, and/or a pointing device) and/or other devices such as accelerator card.

Bus 612 represents one or more of any of a variety of communication bus structures. By way of example, and not limitation, bus 612 may be implemented as a PCIe bus. Bus 612 couples to each of hardware processor 602, memory 604, and I/O interface(s) 610 through respective interface circuitry thereby allowing the devices to communicate. Bus 612 may represent a plurality of buses that may be interconnected and/or hierarchically organized.

In the example of FIG. 6, data processing system 600 is coupled to NPU 110. NPU 110 may be communicatively linked to data processing system 600 by way of any of a variety of communication links such as communication buses, interconnect circuitry, and/or interfaces. Though not illustrated, NPU 110 may be disposed on a circuit board such as a card or in another device or system. Accordingly, data processing system 600 may execute framework 100, load ML design 120 into NPU 110, and perform the debugging operations described herein while ML design 120 executes in NPU 110.

Data processing system 600 is only one example implementation. Data processing system 600 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

As used herein, the term “cloud computing” refers to a computing model that facilitates convenient, on-demand network access to a shared pool of configurable computing resources such as networks, servers, storage, applications, ICs (e.g., programmable ICs) and/or services. These computing resources may be rapidly provisioned and released with minimal management effort or service provider interaction. Cloud computing promotes availability and may be characterized by on-demand self-service, broad network access, resource pooling, rapid elasticity, and measured service.

The example of FIG. 6 is not intended to suggest any limitation as to the scope of use or functionality of example implementations described herein. Data processing system 600 is an example of computer hardware that is capable of performing the various operations described within this disclosure. In this regard, data processing system 600 may include fewer components than shown or additional components not illustrated in FIG. 6 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The terminology used herein is for the purpose of describing particular examples only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “user” refers to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the implementations described herein. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the implementations described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry, in order to perform aspects of the implementations described herein.

Certain aspects of the implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the implementations. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various implementations of the disclosed technology have been presented for purposes of illustration, but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

What is claimed is:

1. A method, comprising:
compiling a machine learning design for execution on target hardware using a compiler;
generating, by the compiler, metadata for the machine learning design, wherein the metadata specifies a mapping of buffers of the machine learning design to a plurality of memory levels of a memory architecture of the target hardware correlated with boundaries of the machine learning design; and
while running the machine learning design, dumping debug data from the plurality of memory levels of the memory architecture based on the boundaries;
wherein the debug data is correlated with the boundaries of the machine learning design based on the metadata.

2. The method of claim 1, wherein the dumping debug data comprises:
dumping data from a selected memory level of the memory architecture in response to a condition indicating a change in data stored by the selected memory level.

3. The method of claim 1, wherein the boundaries of the machine learning design specify iterations of layers of the machine learning design.

4. The method of claim 1, wherein the boundaries of the machine learning design specify layers of the machine learning design.

5. The method of claim 1, wherein the dumping debug data comprises:
setting a start breakpoint and an end breakpoint in each of a plurality of compute tiles of the target hardware.

6. The method of claim 1, wherein the debug data includes state information from one or more registers of the target hardware and is correlated with the one or more components from which the state information is obtained based on the metadata.

7. The method of claim 1, further comprising:
comparing the debug data with reference data; and
indicating an error in response to detecting a mismatch between the debug data and the reference data.

8. The method of claim 7, wherein the comparing is performed on a per-layer basis in response to completing execution of one or more layers of the machine learning design.

9. The method of claim 1, wherein the metadata specifies buffers containing input feature maps, weights, and output feature maps of the machine learning design and addresses of the buffers for the target hardware.

10. The method of claim 1, wherein the dumping debug data is performed by a debug agent executing concurrently with the machine learning design.

11. A system, comprising:
a data processing array including a memory architecture having a plurality of memory levels;
wherein the data processing array is configured to implement a machine learning design and execute iterations and layers of the machine learning design;
a data processing system coupled to the data processing array, wherein the data processing system executes a debug agent that performs operations including:
while the data processing array runs the machine learning design, dumping debug data from the plurality of memory levels of the memory architecture according to boundaries of the machine learning design specified by metadata; and
wherein the debug data is correlated with the boundaries of the machine learning design based on the metadata.

12. The system of claim 11, wherein the dumping debug data comprises:
dumping data from a selected memory level of the memory architecture in response to a condition indicating a change in data stored by the selected memory level.

13. The system of claim 11, wherein the boundaries of the machine learning design specify iterations of layers of the machine learning design.

14. The system of claim 11, wherein the boundaries of the machine learning design specify layers of the machine learning design.

15. The system of claim 11, wherein the dumping debug data comprises:
setting a start breakpoint and an end breakpoint in each of a plurality of compute tiles of the data processing array.

16. The system of claim 11, wherein the debug data includes state information from one or more registers of the data processing array and is correlated with the one or more components from which the state information is obtained based on the metadata.

17. The system of claim 11, wherein the metadata specifies buffers containing input feature maps, weights, and output feature maps of the machine learning design and addresses of the buffers for multi-level memory architecture.

18. A system, comprising:
a hardware processor; and
a computer-readable storage medium having program instructions stored thereon that cause the processor to perform operations including:
compiling a machine learning design for execution on target hardware using a compiler;
generating, by the compiler, metadata for the machine learning design, wherein the metadata specifies a mapping of the machine learning design to hardware components of the target hardware; and
while running the machine learning design, dumping debug data from a plurality of memory levels of a memory architecture of the target hardware according to boundaries of the machine learning design;
wherein the debug data is correlated with the boundaries of the machine learning design based on the metadata.

19. The system of claim 18, further comprising:
the target hardware, wherein machine learning design is run on the target hardware.

20. The system of claim 18, wherein the machine learning design is run on the processor set as a simulation.
